(19) United States
(12) Patent Application Publication
(10) Pub. No.: US 2006/0028443 A1
(43) Pub. Date: Feb. 9, 2006

(54) Method and apparatus for generating and inputting displacement signals

(76) Inventors: Chang-Chu Liu, Hsi Chih City (TW); Jongwen Tsai, Taipei City (TW); Hung-Min Chung, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/912,195

(22) Filed: Aug. 6, 2004

(51) Int. Cl. G09G 5/08

(52) U.S. Cl. 345/157

(57) ABSTRACT

A method and an apparatus for generating and inputting displacement signals, the apparatus being connected to a computer, are described. An acceleration sensor detects acceleration of an object and transforms the acceleration into electric signals. An analog/digital transducer is connected to the acceleration sensor for receiving the electric signals, and transforms the electric signals into digital signals. An acceleration/displacement calculating unit is connected to the analog/digital transducer for receiving the digital signals, and calculates and transforms the digital signals into corresponding displacement signals. A transmitting unit is connected to the acceleration/displacement calculating unit for receiving the displacement signals and transmitting the displacement signals to said computer.

### BACKGROUND OF THE INVENTION

1. Field of the Invention

The present invention is related to a method and an apparatus for generating and inputting displacement signals, and more particularly to a method for transforming acceleration of an object into corresponding displacement signals.

2. Description of Related Art

Computers are indispensable to human daily lives. Each desktop or portable computer has a cursor-controlling device, such as a mouse, to control the displacement of a cursor on a computer screen. Additionally, the cursor is used to select programs in a computer. With the popularization of the Windows Operating System and graphic interfaces of softwares, a mouse is an important input device of computer peripheral equipment. Moreover, a mouse is classified as a “wheeled mouse” or an “optical mouse” according to its detection ways for operation. Furthermore, the appearance of a mouse can be modeled into a streamlines shape according to ergonomics. For example, a “pen-like optical mouse” can be used more conveniently just like a pen, and it can easily be carried with portable computers. However, a mouse has a drawback that it should be used with a mousepad or a flat surface for surface contact to control a cursor; therefore people may not use the mouse efficiently.

### SUMMARY OF THE INVENTION

The objective of the invention is to provide an acceleration sensor in a mouse to detect acceleration of the mouse, and the acceleration is transformed into electric signals. Meanwhile, the electric signals are further transformed into digital signals by a transforming circuit. Then, an acceleration/displacement calculating unit deals with the digital signals and outputs displacement signals corresponding to the acceleration of the mouse; next, the displacement signals are transmitted to a computer through a transmitting unit. Finally, a computer screen shows positions of a cursor controlled by the mouse.

The present invention employs a user-instruction definition unit to receive and deal with the above-mentioned digital signals. Operation signals are output to the computer according to preset digital signals generated by specific motions of the acceleration sensor. Therefore, the mouse can perform button and moving functions.

In a word, the present invention provides a mouse that does not need surface contact with a mousepad or a flat surface, and the form of the mouse can be that of a pen, a glove or a ring.

To provide a further understanding of the invention, the following detailed description illustrates embodiments and examples of the invention, this detailed description being provided only for illustration of the invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of a displacement signals input device of the present invention;

FIG. 2 shows a block diagram of the circuit of the present invention;

FIG. 3 shows a schematic diagram of the relations between velocity, acceleration and time of the present invention; and

FIG. 4 shows a flow chart of the displacement generating method of the present invention.

### DETAILED DESCRIPTION OF PREFERRED EMBODIMENTS

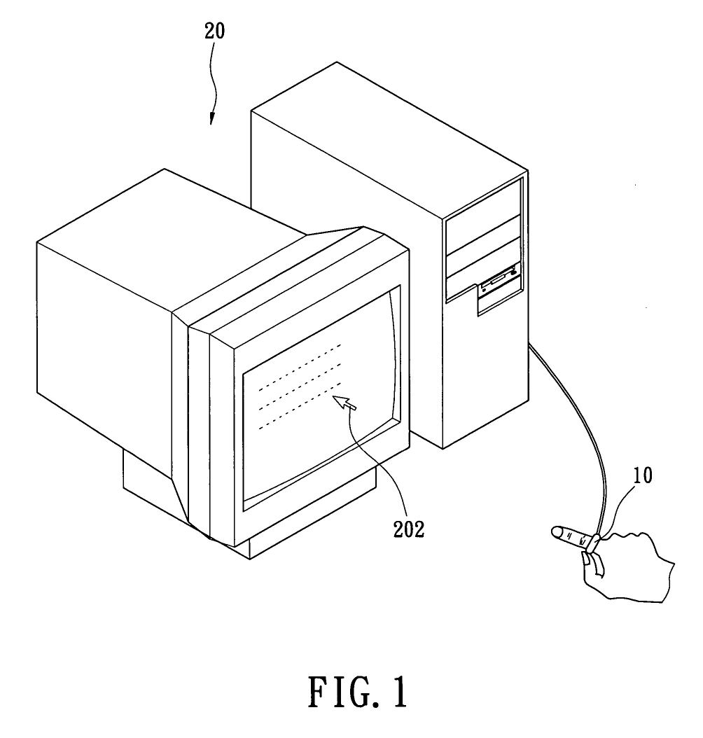

Reference is made to FIG. 1, a schematic diagram of a displacement signals input device 10, in which a ring-like mouse is an embodiment of the present invention. A user can wear the ring-like mouse on a finger and the ring-like mouse swings freely. A control cursor 202 on a computer screen 20 is controlled by the acceleration produced by the swing of the ring-like mouse. Additionally, button and moving functions of the mouse are activated by preset swinging motions.

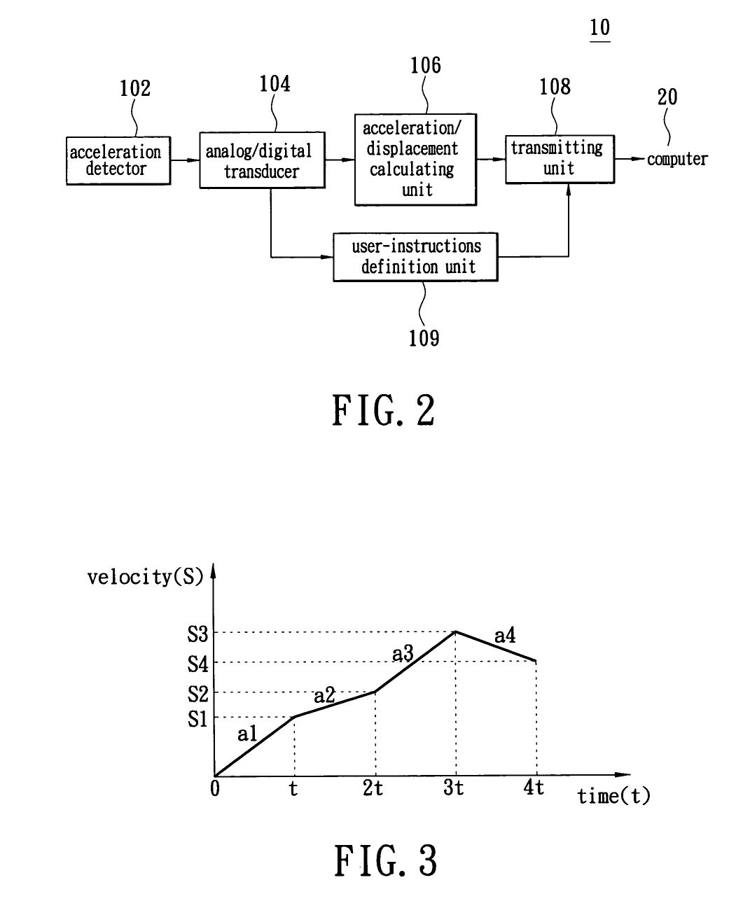

FIG. 2 depicts a schematic block diagram of a circuit of the present invention. The displacement signals input device 10 is connected to a computer 20, which comprises an acceleration sensor 102, an analog/digital transducer 104, an acceleration/displacement calculating unit 106, a transmitting unit 108, and a user-instructions definition unit 109. As FIG. 2 shows, the acceleration detector 102 detects swinging acceleration from the displacement signals input device 10 and transforms the swinging acceleration into corresponding electric signals. The acceleration sensor 102 can detect acceleration on the X, Y, and Z axes, respectively. Moreover, acceleration on the X axis represents left and right motion of the mouse; acceleration on the Y axis represents front and rear motion of the mouse; and acceleration on the Z axis represents up and down motion of the mouse. In addition, when the mouse is at rest, the tilt angle thereof is calculated by the components of acceleration of gravity on the X, Y, and Z axes.

The analog/digital transducer 104 is connected to the acceleration sensor 102 for receiving the electric signals and transforming the electric signals into digital signals for a micro processor and the computer 20. Further, an acceleration/displacement calculating unit 106 is connected to an analog/digital transducer 104, for receiving and calculating the digital signals. Then, the digital signals are transformed into corresponding displacement signals. Meanwhile, a transmitting unit 108, which is connected to the acceleration/displacement calculating unit 106, transmits the displacement signals to the computer 20. Finally, a screen of the computer 20 displays positions of a control cursor synchronously with the movements of the mouse.

FIG. 2 depicts a user-instructions definition unit 109, which is connected to the analog/digital transducer 104 and the transmitting unit 108. The user-instructions definition unit 109 receives the digital signals for outputting operation signals, and the operation signals are transmitted to the computer 20 through the transmitting unit 108. In addition, the user-instructions definition unit 109 compares the digital signals with preset digital signals generated by specific motion of the acceleration sensor 102. Next, operation signals are output after the above-mentioned step. The operating signals are a right button signal, a left button signal and a “raise and lower” signal for a mouse. However, displacement of the mouse is not calculated and transmitted when the mouse is raised; on the other hand, displacement of the mouse is calculated and transmitted again after the mouse is lowered. In addition, the mouse has two operation modes as follows:

a. Operating on desktop mode: when the mouse is accelerated upward, an acceleration signals is generated and defines the mouse as being raised; when the mouse is accelerated downward, an acceleration signals is generated and defines the mouse as being lowered. Without any acceleration signals except that caused by gravity, the mouse is defined as being steady.

b. Operating without contacting with surface mode: the mouse can be moved up, down, left and right and corresponding movements are shown on the computer screen synchronously. Moving backward defines the mouse as being raised, and moving forward defines the mouse as being lowered.

The present invention utilizes specific motion to define the button functions of the mouse. Every object on earth suffers acceleration of gravity, even if it is static. Therefore, tilt angle of the mouse can be calculated by analyzing changes of the acceleration of gravity, and different tilt angles represent different operations. When the mouse is operated without surface contact, inclining to the lower left represents a left button function; inclining to the lower right represents a right button function; inclining to the lower front represents a wheel moving forward; and inclining to the lower back represents a wheel moving backward. Reference is made to FIG. 2, in which the acceleration sensor 102 is a micro electromechanical device and generates corresponding electric signals under acceleration. Meanwhile, the transmitting unit 108 is a wireless transmitting unit or a serial transmitting unit. The wireless transmitting unit is an infrared wireless transmitting unit or a RF wireless transmitting unit, and the serial transmitting unit is a PS2 transmitting unit or a USB transmitting unit.

Reference is made to FIG. 2 again. The acceleration/displacement calculating unit 106 uses the following equation (1) to acquire a velocity signal “s” corresponding to acceleration “a” in a period of time “t”.
s=a*t (1)

In the above-mentioned equation (1), “a” is an acceleration value, “s” is a velocity value and “t” is a time value. And integrating the acceleration “a” by time “t” obtains the velocity “s”. Besides, acceleration/displacement calculating unit 106 uses the equation (1) and a following equation (2) to acquire a displacement signal “d”.
d=s*t+(½)*a*t² (2)

In the above-mentioned equation (2), “d” is a displacement signal, “a” is an acceleration value, “s” is a velocity value and “t” is a time value. Further, integrating the velocity value “s” by time “t” obtains the displacement “d”. Furthermore, acceleration/displacement calculating unit 106 uses the equation (1) and the equation (2) to acquire the displacement signal “d”.

FIG. 3 depicts a schematic diagram of relations between velocity, acceleration, and time of the present invention. A vertical axis of the diagram represents velocity “s” and a transverse axis represents time “t”; the mouse is static at time 0, and velocity “s”, acceleration “a” and time “t” are also with value 0. Acceleration a1 is obtained during the time period 0−t. Therefore, velocity s1 at time t is obtained by using the equation (1): s1=a1*t; displacement d1 is obtained by using the equation (2): d1=(a1*t)*t/2. Acceleration a2 is obtained during the time period t−2t; equally, velocity s2 at time 2t is obtained by using the equation (1): s2=s1±a2*t; and displacement d2 is obtained by using the equation (2): d2=s1*t+(a2*t)*t/2. Further, acceleration a4 is negative in value during the time period 3t-4t, and the velocity s4=s3+a4*t at time 4t is less than velocity s3. Therefore, the value of displacement d4=s3*t+(a4*t)*t/2 obtained by using equation (2) is less than the value s3*t.

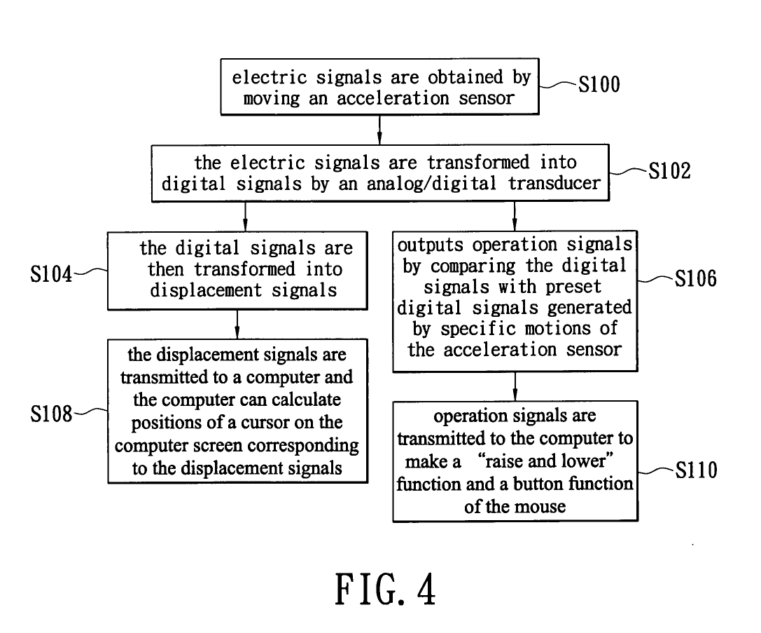

Reference is made to FIG. 4, which shows a schematic block diagram of a displacement signal production method. The steps of the diagram are as follows. First, electric signals are obtained by moving an acceleration sensor S100. The electric signals change with the acceleration of the acceleration sensor, and the electric signals are transformed into digital signals by an analog/digital transducer S102. The digital signals are then transformed into displacement signals by an acceleration/displacement calculating unit S104. Finally, the displacement signals are transmitted to a computer, and the computer can calculate positions of a cursor on the computer screen corresponding to the displacement signals S108. After the above-mentioned step 102, a step S106 outputs operation signals by comparing the digital signals in step S102 with preset digital signals generated by specific motions of the acceleration sensor. Moreover, after the step S106, operation signals are transmitted to the computer in a step S110 to achieve a “raise and lower” function and a button function of the mouse. In addition, the digitals signals are compared by a user-instructions definition unit in step S106.

Above all, the present invention set an acceleration sensor in a mouse for obtaining the acceleration of the mouse. Acceleration on the X axis represents left and right motion of the mouse; acceleration on the Y axis represents front and rear motion of the mouse; and acceleration on the Z axis represents up and down motion of the mouse. In addition, when the mouse is at rest, a tilt angle thereof can be calculated by the components of acceleration of gravity on the X, Y and Z axes. Moreover, the acceleration is transformed into electric signals, and then the electric signals are transformed into digital signals. Meanwhile, an acceleration/displacement calculating unit receives and calculates the digital signals, and the digital signals are transformed into displacement signals corresponding to the acceleration. Next, a transmitting unit transmits the displacement signals to a computer, and a screen of the computer displays positions of a control cursor synchronously with the movement of the mouse.

The present invention uses a user-instructions definition unit to receive the digital signals, and compares the digital signals with preset digital signals generated by specific motion of the acceleration sensor for outputting operation signals to the computer; the operating signals are: a right button signal, a left button signal and a “raise and lower” signal for a mouse. Therefore, the present invention provides a mouse that does not need surface contact with a mousepad or a flat surface, and the form of the mouse can be that of a pen, a glove or a ring.

There has thus been described a new, novel and heretofore unobvious mouse, which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided the fall within the scope of the invention as defined in the following appended claims.

What is claimed is:

1. An apparatus for inputting displacement signals, connected to a computer, comprising:
an acceleration sensor, detecting acceleration of an object and transforming the acceleration into electric signals;
an analog/digital transducer, connected to the acceleration sensor, for receiving the electric signals and transforming the electric signals into digital signals;
an acceleration/displacement calculating unit, connected to the analog/digital transducer, for receiving the digital signals, and calculating and transforming the digital signals into corresponding displacement signals; and
a transmitting unit, connected to the acceleration/displacement calculating unit, for receiving the displacement signals and transmitting the displacement signals to said computer.

2. The apparatus for inputting displacement signals as in claim 1, wherein a user-instructions definition unit is connected to the transmitting unit and the analog/digital transducer for receiving the digital signals and outputting an operation signals, and the operation signals are transmitted to the computer through the transmitting unit.

3. The apparatus for inputting displacement signals as in claim 1, wherein the acceleration sensor is a micro electromechanical device and generates corresponding electric signals under acceleration.

4. The apparatus for inputting displacement signals as in claim 1, wherein the transmitting unit is a wireless transmitting unit.

5. The apparatus for inputting displacement signals as in claim 4, wherein the wireless transmitting unit is an infrared wireless transmitting unit.

6. The apparatus for inputting displacement signals as in claim 4, wherein the wireless transmitting unit is an RF wireless transmitting unit.

7. The apparatus for inputting displacement signals as in claim 1, wherein the transmitting unit is a serial transmitting unit.

8. The apparatus for inputting displacement signals as in claim 7, wherein the serial transmitting unit is a PS2 transmitting unit.

9. The apparatus for inputting displacement signals as in claim 7, wherein the serial transmitting unit is a USB transmitting unit.

10. The apparatus for inputting displacement signals as in claim 2, wherein the operating signals are a right button signal, a left button signal and a moving signal of a mouse.

11. A method for generating displacement signals, comprising:
obtaining electric signals by moving an acceleration sensor;
conforming the electric signals to acceleration changes of the acceleration sensor;
transforming the electric signals into digital signals;
calculating and transforming the digital signals into corresponding displacement signals; and
transmitting the displacement signals to a computer, wherein a position of a cursor corresponding to the displacement signals is defined by the computer.

12. The method for generating displacement signals as in claim 11, wherein the digital signals transformed from the electric signals are compared with preset digital signals generated by specific motions of the acceleration sensor for outputting operating signals.

13. The method for generating displacement signals as in claim 12, wherein the operating signals are transmitted to the computer further for a button function and a “raise and lower” function of a mouse.

14. The method for generating displacement signals as in claim 12, wherein the digital signals transformed from the electric signals are compared by a user-instructions definition unit.
